(19) United States
(12) Patent Application Publication
(10) Pub. No.: US 2024/0265232 A1
(43) Pub. Date: Aug. 8, 2024

(54) METHODS AND APPARATUS TO ACCELERATE CONVOLUTION

(71) Applicant: Intel Corporation, Santa Clara, CA (US)

(72) Inventors: Darren Crews, Portland, OR (US); Yong Jiang, Shanghai (CN); Yuanyuan Li, Shanghai (CN); Xu Qian, Shanghai (CN); Peiqing Jiang, Shanghai (CN); Haiyun Hong, Shanghai (CN)

(21) Appl. No.: 18/565,972

(22) PCT Filed: Sep. 24, 2021
(86) PCT No.: PCT/CN2021/120142

§ 371 Date: Nov. 30, 2023

(51) Int. Cl. G06N 3/04

(52) U.S. Cl. CPC G06N 3/04

(57) ABSTRACT

Methods, apparatus, systems, and articles of manufacture are disclosed. An example apparatus includes at least one memory, instructions in the apparatus, and processor circuitry to execute the instructions to detect a pattern of an upsampled input submatrix, generate a transformed input submatrix by selecting four elements of the upsampled input submatrix, select a transformed weight submatrix based on the pattern, and convolve the transformed input submatrix and the transformed weight submatrix.

### FIELD OF THE DISCLOSURE

This disclosure relates generally to neural networks and, more particularly, to methods and apparatus to accelerate convolution.

### BACKGROUND

In machine learning, a convolutional neural network is a type of feed-forward artificial network which captures spatial and temporal dependencies in images through the application of filters. Convolutional neural networks (CNNs) are widely used throughout computer vision to allow computer systems to derive a high-level understanding of images. Common computer vision tasks include image classification and object detection.

CNNs can be especially useful for imaging tasks. For example, raw pixels from an image may be fed to a series of upsampling layers, convolutional layers, and max-pooling layers. As data moves through the CNN, increasingly abstract features can be extracted from the image. These features can then used for classification.

### BRIEF DESCRIPTION OF THE DRAWINGS

FIG. 1 is a block diagram of an example convolution accelerating system.

FIG. 2 is an illustration of example input matrices.

FIG. 3 is an illustration of an example transformed weight matrix and example matrices to accelerate convolution based on a first sliding window position.

FIG. 4 an illustration of example matrices to accelerate convolution based on a second sliding window position.

FIG. 5 is an illustration of example matrices to accelerate convolution based on a third sliding window position.

FIG. 6 is an illustration of example matrices to accelerate convolution based on a fourth sliding window position.

FIG. 7 is a flowchart representative of example machine readable instructions that may be executed by processor circuitry to implement the convolution accelerating system of FIG. 1.

FIG. 8 is a flowchart representative of example machine readable instructions that may be executed by processor circuitry to implement the accelerated convolution of FIG. 7.

FIG. 9 is a block diagram of an example processing platform including processor circuitry structured to execute the example machine readable instructions of FIGS. 7-8, to implement the example convolution accelerating system of FIG. 1.

FIG. 10 is a block diagram of an example implementation of the processor circuitry of FIG. 9.

FIG. 11 is a block diagram of another example implementation of the processor circuitry of FIG. 9.

FIG. 12 is a block diagram of an example software distribution platform (e.g., one or more servers) to distribute software (e.g., software corresponding to the example machine readable instructions of FIGS. 7-8) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

The figures are not to scale. In general, the same reference numbers will be used throughout the drawing(s) and accompanying written description to refer to the same or like parts.

Notwithstanding the foregoing, in the case of a semiconductor device, “above” is not with reference to Earth, but instead is with reference to a bulk region of a base semiconductor substrate (e.g., a semiconductor wafer) on which components of an integrated circuit are formed. Specifically, as used herein, a first component of an integrated circuit is “above” a second component when the first component is farther away from the bulk region of the semiconductor substrate than the second component. As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween. As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name. As used herein, “approximately” and “about” refer to dimensions that may not be exact due to manufacturing tolerances and/or other real world imperfections. As used herein “substantially real time” refers to occurrence in a near instantaneous manner recognizing there may be real world delays for computing time, transmission, etc. Thus, unless otherwise specified, “substantially real time” refers to real time+/−1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events. As used herein, “processor circuitry” is defined to include (i) one or more special purpose electrical circuits structured to perform specific operation(s) and including one or more semiconductor-based logic devices (e.g., electrical hardware implemented by one or more transistors), and/or (ii) one or more general purpose semiconductor-based electrical circuits programmed with instructions to perform specific operations and including one or more semiconductor-based logic devices (e.g., electrical hardware implemented by one or more transistors). Examples of processor circuitry include programmed microprocessors, Field Programmable Gate Arrays (FPGAs) that may instantiate instructions, Central Processor Units (CPUs), Graphics Processor Units (GPUs), Digital Signal Processors (DSPs), XPUs, or microcontrollers and integrated circuits such as Application Specific Integrated Circuits (ASICs). For example, an XPU may be implemented by a heterogeneous computing system including multiple types of processor circuitry (e.g., one or more FPGAs, one or more CPUs, one or more GPUs, one or more DSPs, etc., and/or a combination thereof) and application programming interface(s) (API(s)) that may assign computing task(s) to whichever one(s) of the multiple types of the processing circuitry is/are best suited to execute the computing task(s).

### DETAILED DESCRIPTION

A convolution layer applies a convolution function or operation to map images of an input layer to the next layer in a CNN. The convolution operation is a linear operation that involves calculating dot products of an input matrix and a matrix of weights called a filter (kernel). The filter is generally smaller than the input matrix and is systematically moved about the input matrix, commonly in a left-to-right, top-to-bottom fashion. This systematic motion is described as a sliding window. As the sliding window moves about the input matrix, the dot product of the filter and the submatrix it overlaps is calculated.

Upsampling layers are a second type of layer which commonly appear in convolutional neural networks. In the context of image processing, an upsampling layer increases the size of an input image. One common upsampling method called nearest neighbor interpolation simply duplicates rows and columns of an input matrix. Upsampling layers are used in computer vision operations such as super resolution, deblur, denoise, and semantic segmentation. Examples disclosed herein use upsampling layers without weights to double each dimension of input data.

Image processing pipelines commonly include upsampling layers followed by convolutional layers. In some examples, a low-resolution feature map goes through an upsampling layer and becomes a high-resolution feature map. The high-resolution feature map is then either fed into the convolution layer directly or can be concatenated with additional feature maps and then sent to the convolution layer.

Examples disclosed herein take advantage of the redundancy inherent in upsampling to accelerate convolution. For example, a 3×3 input may go through an upsampling layer and produce a 6×6 output (e.g., 2× nearest-neighbor upsampling). Of the thirty-six elements in the output, only nine of them are unique. Examples disclosed herein make use of the redundancy of the output of upsampling layers to reduce the number of computations required to complete a convolution. Instead of performing 3×3 convolutions, examples disclosed herein perform 2×2 convolutions on transformed inputs, thereby reducing the number of multiplications.

For example, F(m×n, r×s) can be defined as a convolution function which produces an m×n output with a r×s filter. Then, a F(2×2, 3×3) convolution needs 2×2×3×3=36 multiplications. Examples disclosed herein transform such a convolution into four 2×2 convolutions, with 16 (e.g., 4×2×2=16) operations. Examples disclosed herein thereby reduce the arithmetic complexity of such operations by a factor of 2.25 (e.g., 36/16=2.25).

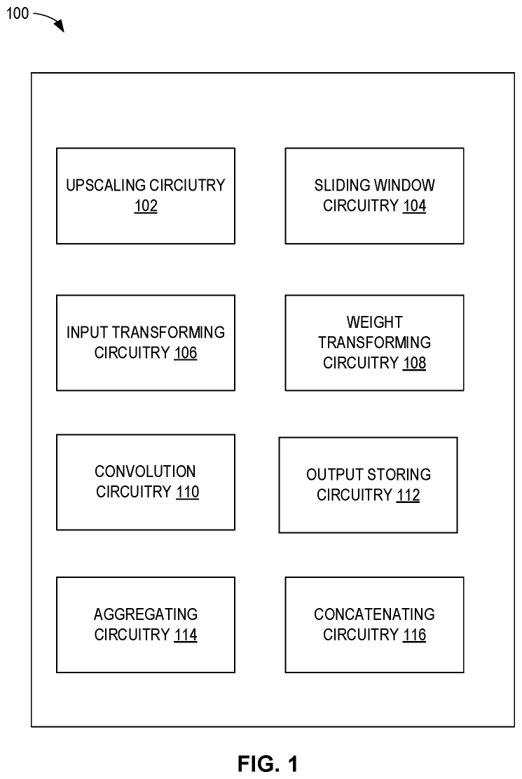

FIG. 1 is a block diagram of an example convolution accelerating system 100. The example convolution accelerating system 100 includes example upscaling circuitry 102, example sliding window circuitry 104, example input transforming circuitry 106, example weight transforming circuitry 108, example convolution circuitry 110, example output storing circuitry 112, example aggregating circuitry 114, and example concatenating circuitry 116.

The example upscaling circuitry 102 upsamples input using nearest neighbor interpolation. For example, the upscaling circuitry may upsample a 3×3 input matrix using nearest neighbor interpolation to generate a 6×6 upsampled input matrix. Although examples disclosed herein describe the upscaling circuitry 102 upscaling a 3×3 input matrix, the upscaling circuitry 102 can upsample a generic input of any dimensionality using nearest neighbor interpolation, bilinear interpolation, bicubic interpolation, spline interpolation, etc.

The sliding window circuitry 104 moves the convolutional filter about an upsampled input matrix. Elements of overlap define upsampled input submatrices which can be further processed by the input transforming circuitry to generate transformed input submatrices. The dimensionality of the sliding window is defined by the size of the weight matrix (e.g., kernel, filter). The example sliding window circuitry 104 moves the weight matrix about an upsampled input matrix in a left-to-right, top-to-bottom manner, covering each element of the upsampled input matrix at least once. In some examples, the sliding window circuitry 104 can move the weight matrix in a different order (e.g., bottom-to-top, right-to-left).

The sliding window circuitry 104 uses a one unit stride. The example sliding window circuitry 104 also controls operation at the boundaries of the upsampled input matrix. For example, the sliding window circuitry 104 keeps the sliding window completely within the upsampled input matrix throughout convolution. In some examples, the sliding window circuitry 104 pads the upsampled input matrix with zeros to make the size of the output the same as the size of the input. In some examples, the sliding window circuitry 104 does not utilize the weight matrix at all. Instead, the sliding window circuitry 104 samples four elements (e.g., corners) of a defined area (e.g., window) for use by the convolution accelerating system 100.

The example input transforming circuitry 106 takes each upsampled input submatrix and transforms each to facilitate accelerated convolution. The example input transforming circuitry 106 transforms 3×3 upsampled input submatrices into 2×2 transformed upsampled input submatrices. The example input transforming circuitry generates each 2×2 transformed upsampled input submatrix by sampling each of the four corners of an upsampled input submatrix.

The example weight transforming circuitry 108 transforms a weight matrix into a transformed weight matrix. The example weight transforming circuitry 108 performs pre-processing on the weight matrix. The pre-processing is performed based on patterns within the input submatrix. In some examples, one 4×4 transformed weight matrix is created. The example transformed weight matrix includes four 2×2 transformed weight submatrices which are used by the convolution circuitry 110. The example transformed weight matrix is representative of redundancies in an upsampled input matrix. Accordingly, different patterns of redundancy in an upsampled input matrix and/or a different weight matrix may correspond to different transformed weight submatrices.

The example convolution circuitry 110 performs convolution. The convolution circuitry 110 convolves a first output including a transformed weight submatrix and a second output including a transformed upsampled input submatrix. The convolution circuitry 110 may then transmit output to the output storing circuitry 112 for storage. The example output storing circuitry 112 may be any one or combination of processor circuitry registers, processor circuitry cache memory, random access memory, etc.

After convolution of an upsampled input matrix is complete, the aggregating circuitry 114 may aggregate output stored in the output storing circuitry 112. The aggregating circuitry 114 takes results stored in the output storing circuitry 112 and aggregates the results into the form of a 3×3 convolution output. Such output can be transferred to a next layer of a neural network and/or concatenated with other output of similar dimensions.

In one example, the convolution accelerating system 100 takes a 3×3 input matrix. The example upscaling circuitry 102 then upsamples (e.g., upsamples) the input matrix to create a 6×6 upsampled input matrix. The sliding window circuitry 104 then moves a weight matrix about the upsampled input matrix in a left-to-right, top-to-bottom manner with a stride length of one and no padding. At each sliding window position, the sliding window circuitry 104 generates an upsampled weight submatrix. Additionally, before the sliding window moves to a next position, the input transforming circuitry generates a transformed upsampled input submatrix from the upsampled input submatrix. The convolution circuitry 110 then performs a convolution on the transformed upsampled input submatrix and a transformed weight submatrix, the transformed weight submatrix pre-generated and selected by the weight transforming circuitry 108. After the set of convolutions is complete, the aggregating circuitry 114 aggregates output saved in the aggregating circuitry 114.

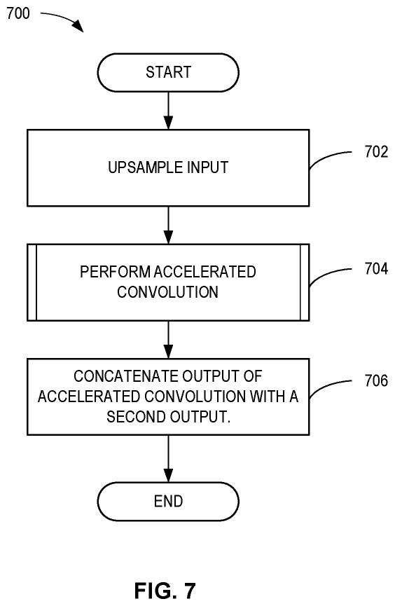

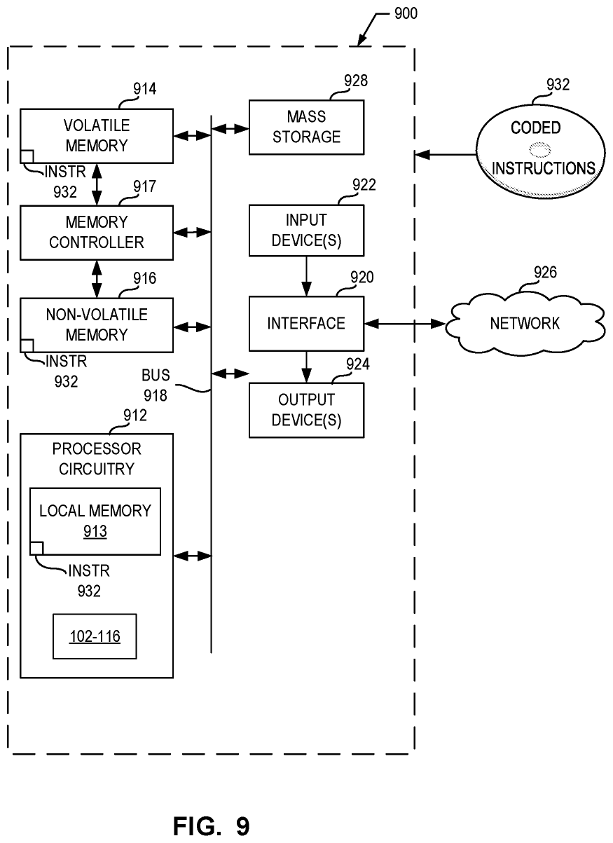

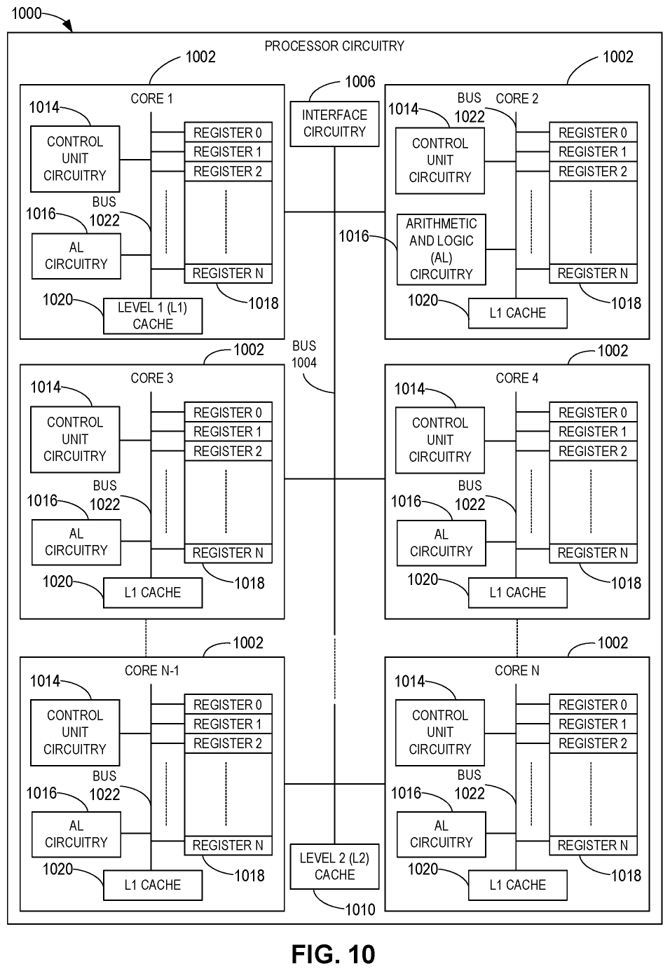

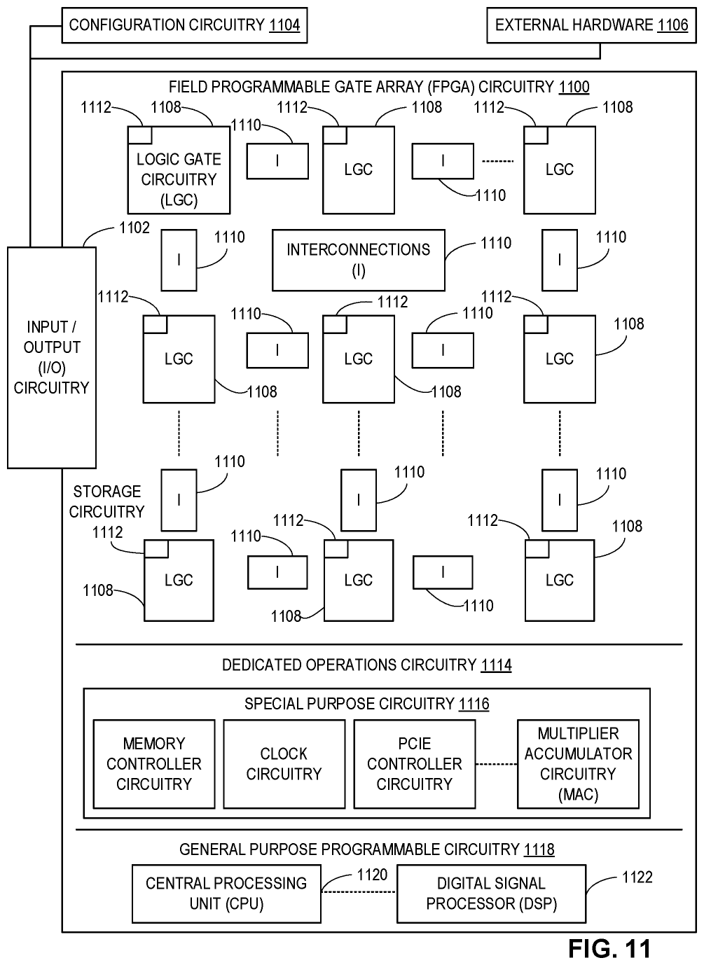

In some examples, the convolution accelerating system 100 includes means for upscaling a matrix. For example, the means for upscaling may be implemented by the upscaling circuitry 102. In some examples, the upscaling circuitry 102 may be implemented by machine executable instructions such as that implemented by at least blocks 702 of FIG. 7 executed by processor circuitry, which may be implemented by the example processor circuitry 912 of FIG. 9, the example processor circuitry 1000 of FIG. 10, and/or the example Field Programmable Gate Array (FPGA) circuitry 1100 of FIG. 11. In other examples, the upscaling circuitry 102 is implemented by other hardware logic circuitry, hardware implemented state machines, and/or any other combination of hardware, software, and/or firmware. For example, the upscaling circuitry 102 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to perform the corresponding operation without executing software or firmware, but other structures are likewise appropriate.

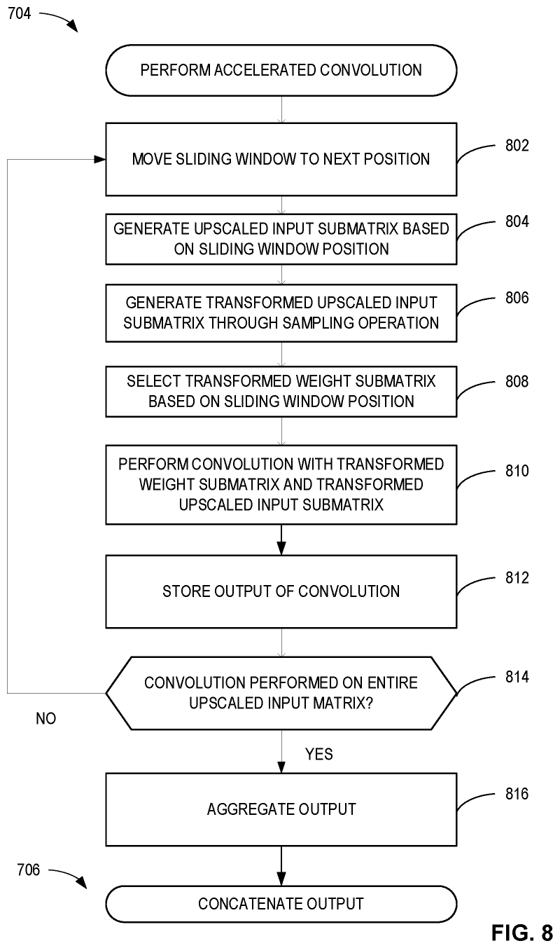

In some examples, the convolution accelerating system 100 includes means for sliding a window. For example, the means for sliding a window may be implemented by the sliding window circuitry 104. In some examples, the sliding window circuitry 104 may be implemented by machine executable instructions such as that implemented by at least blocks 802 of FIG. 8 executed by processor circuitry, which may be implemented by the example processor circuitry 912 of FIG. 9, the example processor circuitry 1000 of FIG. 10, and/or the example Field Programmable Gate Array (FPGA) circuitry 1100 of FIG. 11. In other examples, the sliding window circuitry 104 is implemented by other hardware logic circuitry, hardware implemented state machines, and/or any other combination of hardware, software, and/or firmware. For example, the sliding window circuitry 104 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to perform the corresponding operation without executing software or firmware, but other structures are likewise appropriate.

In some examples, the convolution accelerating system 100 includes means for transforming an input. For example, the means for transforming an input may be implemented by input transforming circuitry 106. In some examples, the input transforming circuitry 106 may be implemented by machine executable instructions such as that implemented by at least blocks 802 of FIG. 8 executed by processor circuitry, which may be implemented by the example processor circuitry 912 of FIG. 9, the example processor circuitry 1000 of FIG. 10, and/or the example Field Programmable Gate Array (FPGA) circuitry 1100 of FIG. 11. In other examples, the input transforming circuitry 106 is implemented by other hardware logic circuitry, hardware implemented state machines, and/or any other combination of hardware, software, and/or firmware. For example, the input transforming circuitry 106 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to perform the corresponding operation without executing software or firmware, but other structures are likewise appropriate.

In some examples, the convolution accelerating system 100 includes means for transforming a weight. For example, the means for transforming a weight may be implemented by weight transforming circuitry 108. In some examples, the weight transforming circuitry 108 may be implemented by machine executable instructions such as that implemented by at least blocks 808 of FIG. 8 executed by processor circuitry, which may be implemented by the example processor circuitry 912 of FIG. 9, the example processor circuitry 1000 of FIG. 10, and/or the example Field Programmable Gate Array (FPGA) circuitry 1100 of FIG. 11. In other examples, the weight transforming circuitry 108 is implemented by other hardware logic circuitry, hardware implemented state machines, and/or any other combination of hardware, software, and/or firmware. For example, the weight transforming circuitry 108 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to perform the corresponding operation without executing software or firmware, but other structures are likewise appropriate.

In some examples, the convolution accelerating system 100 includes means for storing an output. For example, the means for storing an output may be implemented by output storing circuitry 112. In some examples, the output storing circuitry 112 may be implemented by machine executable instructions such as that implemented by at least blocks 812 of FIG. 8 executed by processor circuitry, which may be implemented by the example processor circuitry 912 of FIG. 9, the example processor circuitry 1000 of FIG. 10, and/or the example Field Programmable Gate Array (FPGA) circuitry 1100 of FIG. 11. In other examples, the output storing circuitry 112 is implemented by other hardware logic circuitry, hardware implemented state machines, and/or any other combination of hardware, software, and/or firmware. For example, the output storing circuitry 112 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to perform the corresponding operation without executing software or firmware, but other structures are likewise appropriate.

In some examples, the convolution accelerating system 100 includes means for performing a convolution. For example, the means for performing a convolution may be implemented by the convolution circuitry 110. In some examples, the convolution circuitry 110 may be implemented by machine executable instructions such as that implemented by at least blocks 810 of FIG. 8 executed by processor circuitry, which may be implemented by the example processor circuitry 912 of FIG. 9, the example processor circuitry 1000 of FIG. 10, and/or the example Field Programmable Gate Array (FPGA) circuitry 1100 of FIG. 11. In other examples, the convolution circuitry 110 is implemented by other hardware logic circuitry, hardware implemented state machines, and/or any other combination of hardware, software, and/or firmware. For example, the convolution circuitry 110 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to perform the corresponding operation without executing software or firmware, but other structures are likewise appropriate.

In some examples, the convolution accelerating system 100 includes means for aggregating outputs of a convolution. For example, the means for aggregating outputs of a convolution may be implemented by the aggregating circuitry 114. In some examples, the aggregating circuitry 114 may be implemented by machine executable instructions such as that implemented by at least blocks 810 of FIG. 8 executed by processor circuitry, which may be implemented by the example processor circuitry 912 of FIG. 9, the example processor circuitry 1000 of FIG. 10, and/or the example Field Programmable Gate Array (FPGA) circuitry 1100 of FIG. 11. In other examples, the aggregating circuitry 114 is implemented by other hardware logic circuitry, hardware implemented state machines, and/or any other combination of hardware, software, and/or firmware. For example, the aggregating circuitry 114 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to perform the corresponding operation without executing software or firmware, but other structures are likewise appropriate.

In some examples, the convolution accelerating system 100 includes means for concatenating outputs. For example, the means for concatenating outputs may be implemented by the concatenating circuitry 116. In some examples, the concatenating circuitry 116 may be implemented by machine executable instructions such as that implemented by at least blocks 816 of FIG. 8 executed by processor circuitry, which may be implemented by the example processor circuitry 912 of FIG. 9, the example processor circuitry 1000 of FIG. 10, and/or the example Field Programmable Gate Array (FPGA) circuitry 1100 of FIG. 11. In other examples, the concatenating circuitry 116 is implemented by other hardware logic circuitry, hardware implemented state machines, and/or any other combination of hardware, software, and/or firmware. For example, the concatenating circuitry 116 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to perform the corresponding operation without executing software or firmware, but other structures are likewise appropriate

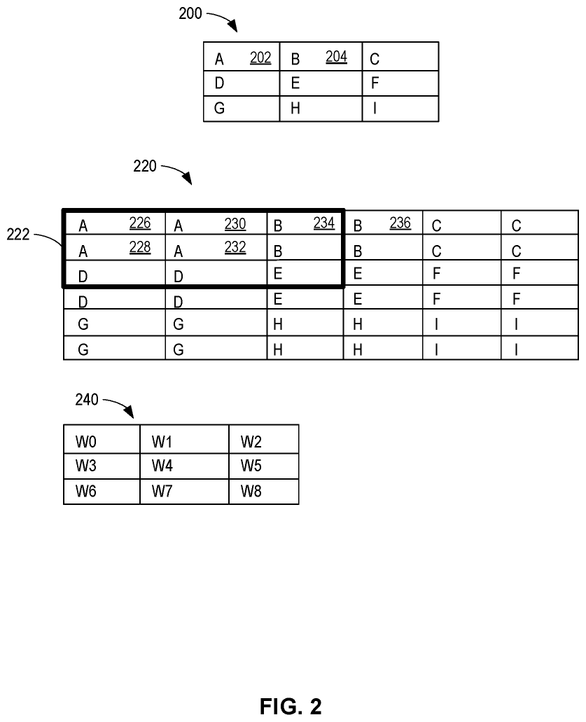

FIG. 2 is an illustration of example input matrices. The example input matrix 200 includes values “a” through “i”. Each value “a”, “b”, . . . , “i” may represent a different value. However, all matrix elements with the same letter (e.g., all “a”) represent the same value. As shown in the example of FIG. 2, some matrices have numbered elements. For example, the input matrix 200 includes a first input element 202, and a second input element 204. In the illustration of FIG. 2, certain matrix elements are numbered (e.g., first input element 202) to illustrate patterns and/or clarify operation of the convolution accelerating system 100.

The upsampled input matrix 220 includes an example first upsampled input element 226, an example second upsampled input element 228, an example third upsampled input element 230, an example fourth upsampled input element 232, an example fifth upsampled input element 234, and an example sixth upsampled input element 236. The upsampled input matrix 220 is the result of a nearest-neighbor upsampling on the input matrix 200. Accordingly, the upsampled input matrix 220 includes duplicates of the first input element 202 and the second input element 204. For example, the upsampled input elements 226-232 include the value “a”, as does the first input element 202.

The upsampled input matrix also has a first sliding window position 222. The first sliding window position 222 includes a 3×3 matrix. Additionally, upsampled input elements 226-234 are included in the first sliding window position 222. FIG. 2 illustrates the sixth upsampled input element 236 is not included in the first sliding window position 222. The weight matrix 240 may be used as a filter (e.g., convolution kernel). The weight matrix 240 includes nine different weights, w0-w9.

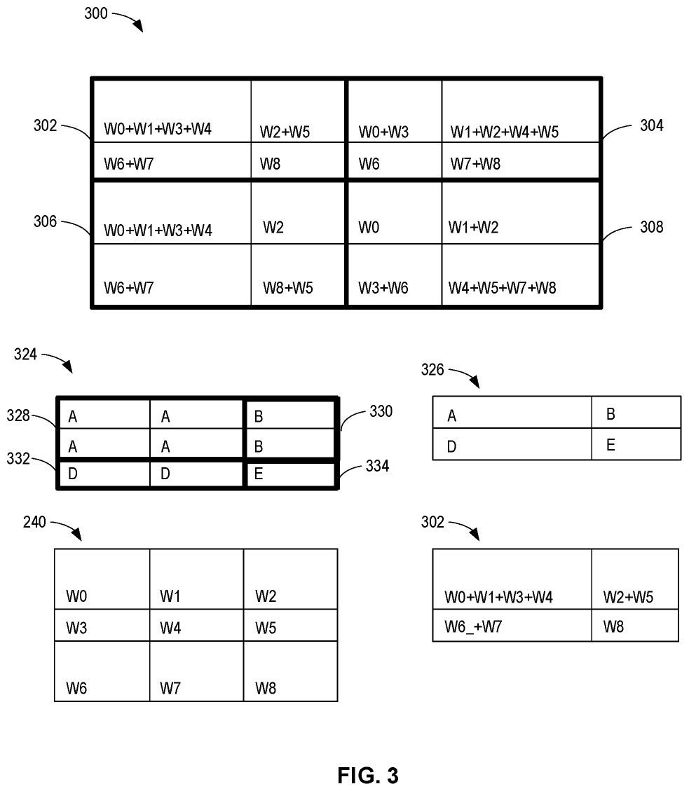

FIG. 3 is an illustration of an example transformed weight matrix 300 and example matrices to accelerate convolution based on the first sliding window position 222. FIG. 3 includes an example first transformed weight submatrix 302, an example second transformed weight submatrix 304, an example third transformed weight submatrix 306, an example fourth transformed weight submatrix 308, an example first upsampled input submatrix 324, and an example first transformed upsampled input submatrix 326.

The example transformed weight matrix 300 is pre-computed based on the type of upsampling (e.g., 2× nearest-neighbor). The computation of the transformed weight matrix 302 is shown below in Equation 1.

$$\begin{matrix}out = {\sum }_{k = 0}^{n} Input [ k ] Weight [ k ] \\ = a * w 0 + a * w 1 + b * w 2 + a * w 3 + a * w 4 + b * w 5 + d * w 6 + d * w 7 + e * w 8 \\ = a * ( w 0 + w 1 + w 3 + w 4 ) + b * ( w 2 + w 5 ) + d * ( w 6 + w 7 ) + e * w 8\end{matrix} \qquad Equation 1$$

A convolution of the first upsampled input submatrix 324 and the weight matrix 240 is shown in Equation 1. Equation 1 generally shows that the output of such a convolution operation is a summation of the element-wise products of each matrix. The final line of Equation 1 shows how each value “a”-“e” can be factored out to form the first transformed weight submatrix 302. In turn, transformed weight submatrices 304-308 can be calculated similarly.

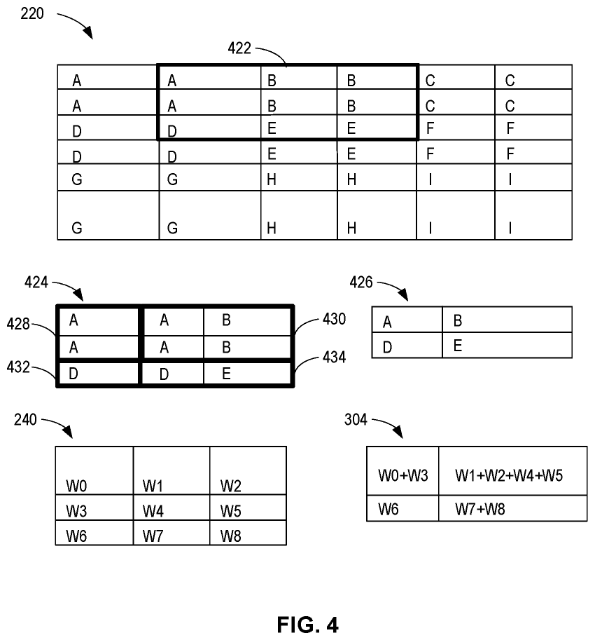

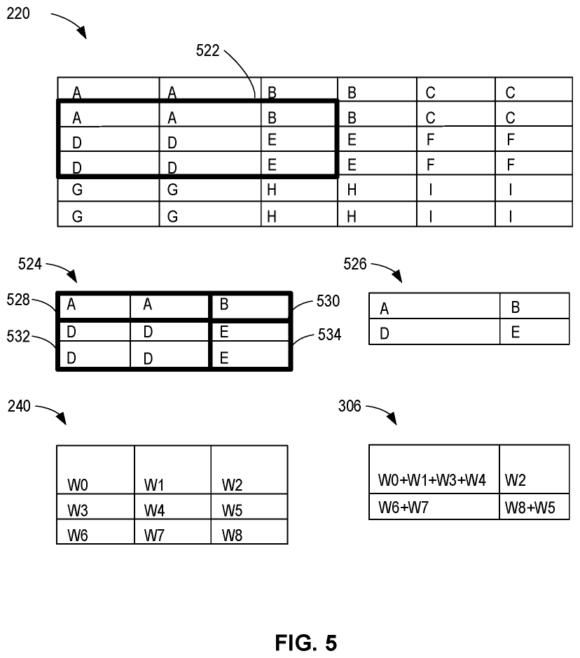

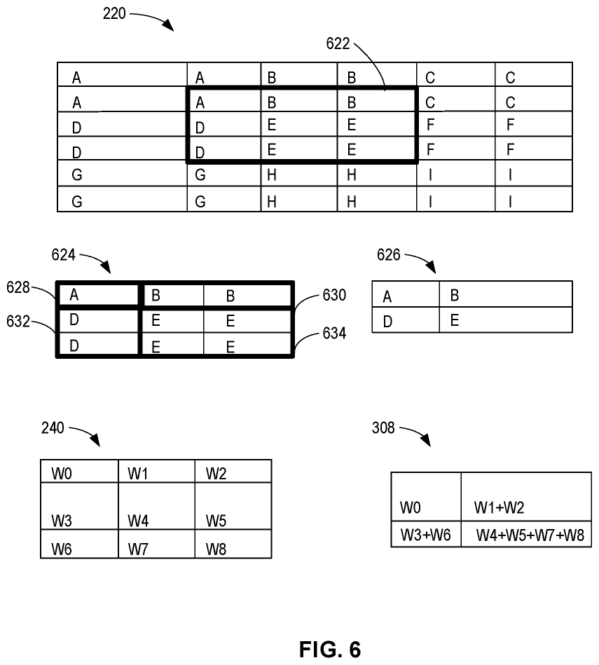

Each of the example upsampled input submatrices 324 of FIG. 3, 424 of FIG. 4, 524 of FIG. 5, and 624 of FIG. 6, has a distinct pattern. Each pattern consists of same-valued elements which appear in the same position of a corresponding upsampled input submatrix. For example, pattern elements for upsampled input submatrix 324 include a first pattern area 328, a second pattern area 330, a third pattern area 332, and a fourth pattern area 334. Each pattern area consists of one or more copies of the same value. For example, the first pattern area 328 consists of value “a” exclusively. The example second pattern area 330 consists of value “b” exclusively. The example third pattern area 332 consists of value “c” exclusively. The example fourth pattern area 334 consists of value “d” exclusively.

Each possible sliding window position of the upsampled input matrix 220 is associated with one of four patterns. The composition of the first pattern is described in association with first transformed upsampled input submatrix 326. Accordingly, upsampled input submatrices 424 of FIG. 4, 524 of FIG. 5, and 624 of FIG. 6 have their own patterns. The first transformed upsampled input submatrix 326 is generated by taking one element from each corner of the first upsampled input submatrix 324.

FIG. 4 is an illustration of example matrices to accelerate convolution based on a second sliding window position. FIG. 4 includes an example second sliding window position 422, an example second upsampled input submatrix 424, an example second transformed upsampled input submatrix 426, an example fifth pattern area 428, an example sixth pattern area 430, an example seventh pattern area 432, and an example eighth pattern area 434.

The example second sliding window position 422 defines the elements to be included in the second upsampled input submatrix 424. The second sliding window position 422 is one unit to the right of the example first sliding window position 222, and therefore includes different elements. Additionally, the second upsampled input submatrix 424 has a different pattern than upsampled input submatrices 324 of FIG. 3, 524 of FIG. 5, and 624 of FIG. 6. The second upsampled input submatrix 424 contains four unique values in patterns, shown in pattern areas 428-434. The second transformed upsampled input submatrix 426 is generated by taking one element from each corner of the second upsampled input submatrix 424.

FIG. 5 is an illustration of example matrices to accelerate convolution based on a third sliding window position. FIG. 5 includes an example third sliding window position 522, an example third upsampled input submatrix 524, an example third transformed upsampled input submatrix 526, an example ninth pattern area 528, an example tenth pattern area 530, an example eleventh pattern area 532, and an example twelfth pattern area 534.

The example third sliding window position 522 defines the elements to be included in the third upsampled input submatrix 524. The third sliding window position 522 is one unit down from the example first sliding window position 222, and therefore includes different elements. Additionally, the third upsampled input submatrix 524 has a different pattern than upsampled input submatrices 324 of FIG. 3, 424 of FIG. 4, and 624 of FIG. 6. The third upsampled input submatrix 524 contains four unique values in patterns, shown in pattern areas 528-534. The third transformed upsampled input submatrix 526 is generated by taking one element from each corner of the upsampled input submatrix 524.

FIG. 6 is an illustration of example matrices to accelerate convolution based on a fourth sliding window position. FIG. 6 includes an example fourth sliding window position 622, an example fourth upsampled input submatrix 624, an example fourth transformed upsampled input submatrix 626, an example thirteenth pattern area 628, an example fourteenth pattern area 630, an example fifteenth pattern area 632, and an example sixteenth pattern area 634.

The example fourth sliding window position 622 defines the elements to be included in the fourth upsampled input submatrix 624. The fourth sliding window position 622 is one unit down and one unit to the right of the example first sliding window position 222, and therefore includes different elements. Additionally, the fourth upsampled input submatrix 624 has a different pattern than the upsampled input submatrices 324 of FIG. 3, 424 of FIG. 4, and 524 of FIG. 5. The fourth upsampled input submatrix 624 contains four unique values in patterns, shown in pattern areas 628-634. The fourth transformed upsampled input submatrix 626 is generated by taking one element from each corner of the upsampled input submatrix 624.

While an example manner of implementing the convolution accelerating circuitry of FIG. 1 is illustrated in FIG. 1, one or more of the elements, processes, and/or devices illustrated in FIG. 1 may be combined, divided, re-arranged, omitted, eliminated, and/or implemented in any other way. Further, the example upscaling circuitry 102, the example sliding window circuitry 104, the example input transforming circuitry 106, the example weight transforming circuitry 108, the example convolution circuitry 110, the example output storing circuitry 112, the example aggregating circuitry 114, the example concatenating circuitry 116 and/or, more generally, the example convolution accelerating system 100 of FIG. 1, may be implemented by hardware, software, firmware, and/or any combination of hardware, software, and/or firmware. Thus, for example, any of the example upscaling circuitry 102, the example sliding window circuitry 104, the example input transforming circuitry 106, the example weight transforming circuitry 108, the example convolution circuitry 110, the example output storing circuitry 112, the example aggregating circuitry 114, the example concatenating circuitry 116, and/or, more generally, the example convolution accelerating circuitry 100, could be implemented by processor circuitry, analog circuit(s), digital circuit(s), logic circuit(s), programmable processor(s), programmable microcontroller(s), graphics processing unit(s) (GPU(s)), digital signal processor(s) (DSP(s)), application specific integrated circuit(s) (ASIC(s)), programmable logic device(s) (PLD(s)), and/or field programmable logic device(s) (FPLD(s)) such as Field Programmable Gate Arrays (FPGAs). When reading any of the apparatus or system claims of this patent to cover a purely software and/or firmware implementation, at least one of the example upscaling circuitry 102, the example sliding window circuitry 104, the example input transforming circuitry 106, the example weight transforming circuitry 108, the example convolution circuitry 110, the example output storing circuitry 112, the example aggregating circuitry 114, the example concatenating circuitry 116 is/are hereby expressly defined to include a non-transitory computer readable storage device or storage disk such as a memory, a digital versatile disk (DVD), a compact disk (CD), a Blu-ray disk, etc., including the software and/or firmware. Further still, the example convolution accelerating system 100 of FIG. 1 may include one or more elements, processes, and/or devices in addition to, or instead of, those illustrated in FIG. 1, and/or may include more than one of any or all of the illustrated elements, processes and devices.

Flowcharts representative of example hardware logic circuitry, machine readable instructions, hardware implemented state machines, and/or any combination thereof for implementing the convolution accelerating system 100 of FIG. 1 is shown in FIGS. 7-8. The machine readable instructions may be one or more executable programs or portion(s) of an executable program for execution by processor circuitry, such as the processor circuitry 912 shown in the example processor platform 900 discussed below in connection with FIG. 9 and/or the example processor circuitry discussed below in connection with FIGS. 10 and/or 11. The program may be embodied in software stored on one or more non-transitory computer readable storage media such as a CD, a floppy disk, a hard disk drive (HDD), a DVD, a Blu-ray disk, a volatile memory (e.g., Random Access Memory (RAM) of any type, etc.), or a non-volatile memory (e.g., FLASH memory, an HDD, etc.) associated with processor circuitry located in one or more hardware devices, but the entire program and/or parts thereof could alternatively be executed by one or more hardware devices other than the processor circuitry and/or embodied in firmware or dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a user) or an intermediate client hardware device (e.g., a radio access network (RAN) gateway that may facilitate communication between a server and an endpoint client hardware device). Similarly, the non-transitory computer readable storage media may include one or more mediums located in one or more hardware devices. Further, although the example program is described with reference to the flowchart illustrated in FIG. 9, many other methods of implementing the example convolution accelerating system 100 may alternatively be used. For example, the order of execution of the blocks may be changed, and/or some of the blocks described may be changed, eliminated, or combined. Additionally or alternatively, any or all of the blocks may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more hardware devices (e.g., a single-core processor (e.g., a single core central processor unit (CPU)), a multi-core processor (e.g., a multi-core CPU), etc.) in a single machine, multiple processors distributed across multiple servers of a server rack, multiple processors distributed across one or more server racks, a CPU and/or a FPGA located in the same package (e.g., the same integrated circuit (IC) package or in two or more separate housings, etc.).

The machine readable instructions described herein may be stored in one or more of a compressed format, an encrypted format, a fragmented format, a compiled format, an executable format, a packaged format, etc. Machine readable instructions as described herein may be stored as data or a data structure (e.g., as portions of instructions, code, representations of code, etc.) that may be utilized to create, manufacture, and/or produce machine executable instructions. For example, the machine readable instructions may be fragmented and stored on one or more storage devices and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of machine executable instructions that implement one or more operations that may together form a program such as that described herein.

In another example, the machine readable instructions may be stored in a state in which they may be read by processor circuitry, but require addition of a library (e.g., a dynamic link library (DLL)), a software development kit (SDK), an application programming interface (API), etc., in order to execute the machine readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable media, as used herein, may include machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 7-8 may be implemented using executable instructions (e.g., computer and/or machine readable instructions) stored on one or more non-transitory computer and/or machine readable media such as optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms non-transitory computer readable medium and non-transitory computer readable storage medium is expressly defined to include any type of computer readable storage device and/or storage disk and to exclude propagating signals and to exclude transmission media.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements or method actions may be implemented by, e.g., the same entity or object. Additionally, although individual features may be included in different examples or claims, these may possibly be combined, and the inclusion in different examples or claims does not imply that a combination of features is not feasible and/or advantageous.

FIG. 7 is a flowchart representative of example machine readable instructions and/or example operations 700 that may be executed and/or instantiated by processor circuitry to accelerate convolution. The machine readable instructions and/or operations 700 of FIG. 4 begin at block 702, at which the upscaling circuitry 102 of FIG. 1 upsamples the input matrix 200 of FIG. 2 to create the first upsampled input matrix 220 of FIG. 2. The example upscaling circuitry 102 of FIG. 1 performs a nearest neighbor interpolation. In some examples, a nearest neighbor interpolation is carried out by duplicating all rows a number of times and then duplicating all columns the same number of times.

At block 704, the convolution accelerating system 100 of FIG. 1 performs accelerated convolution. The accelerated convolution of block 704 are described in further detail below in association with FIG. 8.

Finally, at block 706, the concatenating circuitry 116 of FIG. 1 concatenates a first output of the accelerated convolution with a second output. In operation, the concatenating circuitry 116 of FIG. 1 takes at least two inputs and concatenates them along a specified dimension. For example, the first output may be generated by the convolution accelerating system 100 and be associated with relatively high-level features. The second output may be associated with relatively low-level features. By concatenating the high-level features with the low-level features, the concatenating circuitry 116 of FIG. 1 may facilitate learning of new features based on the concatenation.

FIG. 8 is a flowchart representative of example machine readable instructions and/or example operations 704 that may be executed and/or instantiated by processor circuitry to perform accelerated convolution. The machine readable instructions and/or operations 704 of FIG. 8 begin at block 802, at which the sliding window circuitry 104 of FIG. 1 moves a sliding window about the upsampled input matrix 220 of FIG. 2. The example sliding window circuitry 104 of FIG. 1 moves generally in a left-to-right, top-to-bottom manner. In some examples, the sliding window circuitry 104 of FIG. 1 may move in a bottom-to-top, right-to-left, etc., without affecting the output.

At block 804, the sliding window circuitry 104 of FIG. 1 generates the first upsampled input submatrix 324 of FIG. 3 based on the first sliding window position 222 of FIG. 2. The example sliding window circuitry 104 of FIG. 1 moves with a stride length of 1. In some examples, the sliding window circuitry 104 of FIG. 1 may use an increased slide length. In general, an increased stride length may reduce a number of operations but result in unused information.

At block 806, the input transforming circuitry 106 of FIG. 1 generates the first transformed upsampled input submatrix 326 of FIG. 3 through a sampling operation. The example input transforming circuitry 106 of FIG. 1 uses a four corners sampling operation, in which one element from each corner of the upsampled input submatrix 326 of FIG. 3 is selected. In some examples, a non-four corners sampling operation is be used. For example, a non-four corners sampling operation may be based on pattern areas of an input submatrix (e.g., the pattern areas 328-334 of FIG. 3).

At block 808, the weight transforming circuitry 108 of FIG. 1 selects the first transformed weight submatrix 302 of FIG. 3 based on the first sliding window position 222 of FIG. 2. The example first transformed weight submatrix 302 is representative of redundancies in the upsampled input matrix 220 from a nearest neighbor upscaling. In some examples, additional or alternative upscaling methods may be used in association with a single transformed weight submatrix.

At block 810, the convolution circuitry 110 of FIG. 1 performs a convolution with the transformed first weight submatrix 302 of FIG. 3 and the first transformed upsampled input submatrix 326 of FIG. 3. The convolution operation of block 810 consists of a summation of an elementwise multiplication of the first transformed weight submatrix 302 of FIG. 3 and the first transformed upsampled inputs submatrix 326 of FIG. 3. At block 812, the output storing circuitry 112 of FIG. 1 stores the summation in processor circuitry cache memory.

At block 814, the sliding window circuitry 104 of FIG. 1 determines whether a convolution has been performed on the entire first upsampled input submatrix 324 of FIG. 3. The sliding window circuitry 104 of FIG. 1 may, for example, determine convolution on the upsampled input matrix 220 of FIG. 2 is complete when a bottom right element has been included in an operation (e.g., a final element when operating left-to-right, top-to-bottom). In some examples, the sliding window circuitry 104 of FIG. 1 may determine if the convolutions are complete based on a counter of stored outputs in the output storing circuitry 112 of FIG. 1.

If convolution has been performed on the entire upsampled input submatrix (e.g., block 814 returns a result of YES), at block 816 the output is aggregated by the aggregating circuitry 114 of FIG. 1 and prepared for concatenation. The aggregating circuitry 114 of FIG. 1 retrieves individual results stored in the output storing circuitry 112 of FIG. 1 and puts them in an ordered structure to facilitate concatenation of with other output of similar dimensions.

If the convolution has not been performed on the entire first upsampled input submatrix 324 of FIG. 3 (e.g., block 814 returns a result of NO), the sliding window circuitry 104 of FIG. 1 moves to a next sliding window position at block 802, repeating the process.

FIG. 9 is a block diagram of an example processor platform 900 structured to execute and/or instantiate the machine readable instructions and/or operations of FIGS. 7-8 to implement the convolution accelerating system 100 of FIG. 1. The processor platform 900 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing device.

The processor platform 900 of the illustrated example includes processor circuitry 912. The processor circuitry 912 of the illustrated example is hardware. For example, the processor circuitry 912 can be implemented by one or more integrated circuits, logic circuits, FPGAs microprocessors, CPUs, GPUs, DSPs, and/or microcontrollers from any desired family or manufacturer. The processor circuitry 912 may be implemented by one or more semiconductor based (e.g., silicon based) devices. In this example, the processor circuitry 912 implements the example upscaling circuitry 102, the example sliding window circuitry 104, the example input transforming circuitry 106, the example weight transforming circuitry 108, the example convolution circuitry 110, the example output storing circuitry 112, the example aggregating circuitry 114, and the example concatenating circuitry 116.

The processor circuitry 912 of the illustrated example includes a local memory 913 (e.g., a cache, registers, etc.). The processor circuitry 912 of the illustrated example is in communication with a main memory including a volatile memory 914 and a non-volatile memory 916 by a bus 918. The volatile memory 914 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 916 may be implemented by flash memory and/or any other desired type of memory device. Access to the main memory 914, 916 of the illustrated example is controlled by a memory controller 917.

The processor platform 900 of the illustrated example also includes interface circuitry 920. The interface circuitry 920 may be implemented by hardware in accordance with any type of interface standard, such as an Ethernet interface, a universal serial bus (USB) interface, a Bluetooth® interface, a near field communication (NFC) interface, a PCI interface, and/or a PCIe interface.

In the illustrated example, one or more input devices 922 are connected to the interface circuitry 920. The input device(s) 922 permit(s) a user to enter data and/or commands into the processor circuitry 912. The input device(s) 922 can be implemented by, for example, an audio sensor, a microphone, a camera (still or video), a keyboard, a button, a mouse, a touchscreen, a track-pad, a trackball, an isopoint device, and/or a voice recognition system.

One or more output devices 924 are also connected to the interface circuitry 920 of the illustrated example. The output devices 924 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 920 of the illustrated example, thus, typically includes a graphics driver card, a graphics driver chip, and/or graphics processor circuitry such as a GPU.

The interface circuitry 920 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 926. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The processor platform 900 of the illustrated example also includes one or more mass storage devices 928 to store software and/or data. Examples of such mass storage devices 928 include magnetic storage devices, optical storage devices, floppy disk drives, HDDs, CDs, Blu-ray disk drives, redundant array of independent disks (RAID) systems, solid state storage devices such as flash memory devices, and DVD drives.

The machine executable instructions 932, which may be implemented by the machine readable instructions of FIGS. 7-8, may be stored in the mass storage device 928, in the volatile memory 914, in the non-volatile memory 916, and/or on a removable non-transitory computer readable storage medium such as a CD or DVD.

FIG. 5 is a block diagram of an example implementation of the processor circuitry 912 of FIG. 9. In this example, the processor circuitry 912 of FIG. 9 is implemented by a microprocessor 1000. For example, the microprocessor 1000 may implement multi-core hardware circuitry such as a CPU, a DSP, a GPU, an XPU, etc. Although it may include any number of example cores 1002 (e.g., 1 core), the microprocessor 1000 of this example is a multi-core semiconductor device including N cores. The cores 1002 of the microprocessor 1000 may operate independently or may cooperate to execute machine readable instructions. For example, machine code corresponding to a firmware program, an embedded software program, or a software program may be executed by one of the cores 1002 or may be executed by multiple ones of the cores 1002 at the same or different times. In some examples, the machine code corresponding to the firmware program, the embedded software program, or the software program is split into threads and executed in parallel by two or more of the cores 1002. The software program may correspond to a portion or all of the machine readable instructions and/or operations represented by the flowcharts of FIGS. 7-8.

The cores 1002 may communicate by an example bus 1004. In some examples, the bus 1004 may implement a communication bus to effectuate communication associated with one(s) of the cores 1002. For example, the bus 1004 may implement at least one of an Inter-Integrated Circuit (I2C) bus, a Serial Peripheral Interface (SPI) bus, a PCI bus, or a PCIe bus. Additionally or alternatively, the bus 1004 may implement any other type of computing or electrical bus. The cores 1002 may obtain data, instructions, and/or signals from one or more external devices by example interface circuitry 1006. The cores 1002 may output data, instructions, and/or signals to the one or more external devices by the interface circuitry 1006. Although the cores 1002 of this example include example local memory 1020 (e.g., Level 1 (L1) cache that may be split into an L1 data cache and an L1 instruction cache), the microprocessor 1000 also includes example shared memory 1010 that may be shared by the cores (e.g., Level 2 (L2_ cache)) for high-speed access to data and/or instructions. Data and/or instructions may be transferred (e.g., shared) by writing to and/or reading from the shared memory 1010. The local memory 1020 of each of the cores 1002 and the shared memory 1010 may be part of a hierarchy of storage devices including multiple levels of cache memory and the main memory (e.g., the main memory 414, 416 of FIG. 4). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1002 may be referred to as a CPU, DSP, GPU, etc., or any other type of hardware circuitry. Each core 1002 includes control unit circuitry 1014, arithmetic and logic (AL) circuitry (sometimes referred to as an ALU) 1016, a plurality of registers 1018, the L1 cache 1020, and an example bus 1022. Other structures may be present. For example, each core 1002 may include vector unit circuitry, single instruction multiple data (SIMD) unit circuitry, load/store unit (LSU) circuitry, branch/jump unit circuitry, floating-point unit (FPU) circuitry, etc. The control unit circuitry 1014 includes semiconductor-based circuits structured to control (e.g., coordinate) data movement within the corresponding core 1002. The AL circuitry 1016 includes semiconductor-based circuits structured to perform one or more mathematic and/or logic operations on the data within the corresponding core 1002. The AL circuitry 1016 of some examples performs integer based operations. In other examples, the AL circuitry 1016 also performs floating point operations. In yet other examples, the AL circuitry 1016 may include first AL circuitry that performs integer based operations and second AL circuitry that performs floating point operations. In some examples, the AL circuitry 1016 may be referred to as an Arithmetic Logic Unit (ALU). The registers 1018 are semiconductor-based structures to store data and/or instructions such as results of one or more of the operations performed by the AL circuitry 1016 of the corresponding core 1002. For example, the registers 1018 may include vector register(s), SIMD register(s), general purpose register(s), flag register(s), segment register(s), machine specific register(s), instruction pointer register(s), control register(s), debug register(s), memory management register(s), machine check register(s), etc. The registers 1018 may be arranged in a bank as shown in FIG. 10. Alternatively, the registers 1018 may be organized in any other arrangement, format, or structure including distributed throughout the core 1002 to shorten access time. The bus 1020 may implement at least one of an I2C bus, a SPI bus, a PCI bus, or a PCIe bus

Each core 1002 and/or, more generally, the microprocessor 1000 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1000 is a semiconductor device fabricated to include many transistors interconnected to implement the structures described above in one or more integrated circuits (ICs) contained in one or more packages. The processor circuitry may include and/or cooperate with one or more accelerators. In some examples, accelerators are implemented by logic circuitry to perform certain tasks more quickly and/or efficiently than can be done by a general purpose processor. Examples of accelerators include ASICs and FPGAs such as those discussed herein. A GPU or other programmable device can also be an accelerator. Accelerators may be on-board the processor circuitry, in the same chip package as the processor circuitry and/or in one or more separate packages from the processor circuitry.

FIG. 11 is a block diagram of another example implementation of the processor circuitry 912 of FIG. 9. In this example, the processor circuitry 912 is implemented by FPGA circuitry 1100. The FPGA circuitry 1100 can be used, for example, to perform operations that could otherwise be performed by the example microprocessor 1000 of FIG. 10 executing corresponding machine readable instructions. However, once configured, the FPGA circuitry 1100 instantiates the machine readable instructions in hardware and, thus, can often execute the operations faster than they could be performed by a general purpose microprocessor executing the corresponding software.

More specifically, in contrast to the microprocessor 1000 of FIG. 10 described above (which is a general purpose device that may be programmed to execute some or all of the machine readable instructions represented by the flowcharts of FIGS. 7-8 but whose interconnections and logic circuitry are fixed once fabricated), the FPGA circuitry 1100 of the example of FIG. 11 includes interconnections and logic circuitry that may be configured and/or interconnected in different ways after fabrication to instantiate, for example, some or all of the machine readable instructions represented by the flowchart of FIGS. 7-8. In particular, the FPGA 1100 may be thought of as an array of logic gates, interconnections, and switches. The switches can be programmed to change how the logic gates are interconnected by the interconnections, effectively forming one or more dedicated logic circuits (unless and until the FPGA circuitry 1100 is reprogrammed). The configured logic circuits enable the logic gates to cooperate in different ways to perform different operations on data received by input circuitry. Those operations may correspond to some or all of the software represented by the flowchart of FIGS. 7-8. As such, the FPGA circuitry 1100 may be structured to effectively instantiate some or all of the machine readable instructions of the flowcharts of FIGS. 7-8 as dedicated logic circuits to perform the operations corresponding to those software instructions in a dedicated manner analogous to an ASIC. Therefore, the FPGA circuitry 1100 may perform the operations corresponding to the some or all of the machine readable instructions of FIGS. 7-8 faster than the general purpose microprocessor can execute the same.

In the example of FIG. 11, the FPGA circuitry 1100 is structured to be programmed (and/or reprogrammed one or more times) by an end user by a hardware description language (HDL) such as Verilog. The FPGA circuitry 1100 of FIG. 11, includes example input/output (I/O) circuitry 1102 to obtain and/or output data to/from example configuration circuitry 1104 and/or external hardware (e.g., external hardware circuitry) 1106. For example, the configuration circuitry 1104 may implement interface circuitry that may obtain machine readable instructions to configure the FPGA circuitry 1100, or portion(s) thereof. In some such examples, the configuration circuitry 1104 may obtain the machine readable instructions from a user, a machine (e.g., hardware circuitry (e.g., programmed or dedicated circuitry) that may implement an Artificial Intelligence/Machine Learning (AI/ML) model to generate the instructions), etc. In some examples, the external hardware 1106 may implement the microprocessor 1000 of FIG. 10. The FPGA circuitry 1100 also includes an array of example logic gate circuitry 1108, a plurality of example configurable interconnections 1110, and example storage circuitry 1112. The logic gate circuitry 1108 and interconnections 1110 are configurable to instantiate one or more operations that may correspond to at least some of the machine readable instructions of FIGS. 7-8 and/or other desired operations. The logic gate circuitry 1108 shown in FIG. 11 is fabricated in groups or blocks. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1108 to enable configuration of the electrical structures and/or the logic gates to form circuits to perform desired operations. The logic gate circuitry 1108 may include other electrical structures such as look-up tables (LUTs), registers (e.g., flip-flops or latches), multiplexers, etc.

The interconnections 1110 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1108 to program desired logic circuits.

The storage circuitry 1112 of the illustrated example is structured to store result(s) of the one or more of the operations performed by corresponding logic gates. The storage circuitry 1112 may be implemented by registers or the like. In the illustrated example, the storage circuitry 1112 is distributed amongst the logic gate circuitry 1108 to facilitate access and increase execution speed.

The example FPGA circuitry 1100 of FIG. 11 also includes example Dedicated Operations Circuitry 1114. In this example, the Dedicated Operations Circuitry 1114 includes special purpose circuitry 1116 that may be invoked to implement commonly used functions to avoid the need to program those functions in the field. Examples of such special purpose circuitry 1116 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1100 may also include example general purpose programmable circuitry 1118 such as an example CPU 1120 and/or an example DSP 1122. Other general purpose programmable circuitry 1118 may additionally or alternatively be present such as a GPU, an XPU, etc., that can be programmed to perform other operations.

Although FIGS. 10 and 11 illustrate two example implementations of the processor circuitry 912 of FIG. 9, many other approaches are contemplated. For example, as mentioned above, modern FPGA circuitry may include an on-board CPU, such as one or more of the example CPU 1120 of FIG. 11. Therefore, the processor circuitry 912 of FIG. 9 may additionally be implemented by combining the example microprocessor 1000 of FIG. 10 and the example FPGA circuitry 1100 of FIG. 11. In some such hybrid examples, a first portion of the machine readable instructions represented by the flowchart of FIGS. 7-8 may be executed by one or more of the cores 1002 of FIG. 10 and a second portion of the machine readable instructions represented by the flowcharts of FIGS. 7-8 may be executed by the FPGA circuitry 1100 of FIG. 11.

In some examples, the processor circuitry 912 of FIG. 9 may be in one or more packages. For example, the processor circuitry 1000 of FIG. 10 and/or the FPGA circuitry 1100 of FIG. 11 may be in one or more packages. In some examples, an XPU may be implemented by the processor circuitry 912 of FIG. 9, which may be in one or more packages. For example, the XPU may include a CPU in one package, a DSP in another package, a GPU in yet another package, and an FPGA in still yet another package.

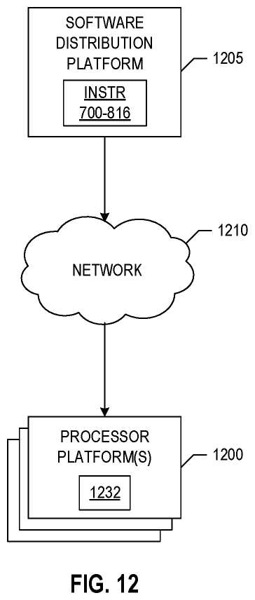

A block diagram illustrating an example software distribution platform 1205 to distribute software such as the example machine readable instructions 700-816 of FIGS. 7-8 to hardware devices owned and/or operated by third parties is illustrated in FIG. 12. The example software distribution platform 1205 may be implemented by any computer server, data facility, cloud service, etc., capable of storing and transmitting software to other computing devices. The third parties may be customers of the entity owning and/or operating the software distribution platform 1205. For example, the entity that owns and/or operates the software distribution platform 1205 may be a developer, a seller, and/or a licensor of software such as the example machine readable instructions 700-816 of FIGS. 7-8. The third parties may be consumers, users, retailers, OEMs, etc., who purchase and/or license the software for use and/or re-sale and/or sub-licensing. In the illustrated example, the software distribution platform 1205 includes one or more servers and one or more storage devices. The storage devices store the machine readable instructions 1232, which may correspond to the example machine readable instructions 700-816 of FIGS. 7-8, as described above. The one or more servers of the example software distribution platform 1205 are in communication with a network 1210, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 1232 from the software distribution platform 1205. For example, the software, which may correspond to the example machine readable instructions 700-816 of FIGS. 7-8, may be downloaded to the example processor platform 1200, which is to execute the machine readable instructions 1232 to implement the convolution accelerating system 100 of FIG. 1. In some examples, one or more servers of the software distribution platform 1205 periodically offer, transmit, and/or force updates to the software (e.g., the example machine readable instructions 1232 of FIG. 12) to ensure improvements, patches, updates, etc., are distributed and applied to the software at the end user devices.

From the foregoing, it will be appreciated that example systems, methods, apparatus, and articles of manufacture have been disclosed that accelerate convolution. The disclosed systems, methods, apparatus, and articles of manufacture improve the efficiency of using a computing device by reducing the number of computations required for convolution. Examples disclosed herein make use of the redundancy of the output of upsampling layers to reduce the number of computations required to complete a convolutions. In some examples, instead of performing 3×3 convolutions, the convolution accelerating system 100 of FIG. 1 performs 2×2 convolutions on transformed inputs, thereby reducing the number of multiplications.

The disclosed systems, methods, apparatus, and articles of manufacture are accordingly directed to one or more improvement(s) in the operation of a machine such as a computer or other electronic and/or mechanical device. Examples disclosed herein thereby reduce the arithmetic complexity of such operations by a factor of 2.25.

Although certain example systems, methods, apparatus, and articles of manufacture have been disclosed herein, the scope of coverage of this patent is not limited thereto. On the contrary, this patent covers all systems, methods, apparatus, and articles of manufacture fairly falling within the scope of the claims of this patent.

Example methods, apparatus, systems, and articles of manufacture to accelerate convolution are disclosed herein. Further examples and combinations thereof include the following:

Example 1 includes an apparatus comprising at least one memory, instructions in the apparatus, and processor circuitry to execute the instructions to detect a pattern of an upsampled input submatrix, generate a transformed input submatrix by selecting four elements of the upsampled input submatrix, select a transformed weight submatrix based on the pattern, and convolve the transformed input submatrix and the transformed weight submatrix.

Example 2 includes the apparatus of example 1, wherein the upsampled input submatrix is based on an upsampled input matrix, the upsampled input matrix generated by nearest neighbor upsampling of an input matrix.

Example 3 includes the apparatus of example 1, wherein the upsampled input submatrix is a 3×3 matrix.

Example 4 includes the apparatus of any one of examples 1 to 3, wherein the transformed input submatrix is a 2×2 matrix and the transformed weight submatrix is a 2×2 matrix.

Example 5 includes the apparatus of any one of examples 1 to 3, wherein the processor circuitry is to execute the instructions to select the upsampled input submatrix based on a position of a sliding window.

Example 6 includes the apparatus of any one of examples 1 to 3, wherein the selected four elements of the upsampled input submatrix correspond to four corners of the upsampled input submatrix.

Example 7 includes the apparatus of any one of examples 1 to 3, wherein the processor circuitry is to execute the instructions to aggregate a plurality of convolved outputs, the convolved outputs generated by the convolving.

Example 8 includes a computer readable medium comprising instructions, which, when executed, cause processor circuitry to at least detect a pattern of an upsampled input submatrix, generate a transformed input submatrix by selecting four elements of the upsampled input submatrix, select a transformed weight submatrix based on the pattern, and convolve the transformed input submatrix and the transformed weight submatrix. In some examples, the computer readable medium may be a non-transitory computer readable medium.

Example 9 includes the computer readable medium of example 8, wherein the upsampled input submatrix is based on an upsampled input matrix, the upsampled input matrix generated by nearest neighbor upsampling of an input matrix.

Example 10 includes the computer readable medium of example 8, wherein the upsampled input submatrix is a 3×3 matrix.

Example 11 includes the computer readable medium of any one of examples 8 to 10, wherein the transformed input submatrix is a 2×2 matrix and the transformed weight submatrix is a 2×2 matrix.

Example 12 includes the computer readable medium of any one of examples 8 to 10, wherein the instructions, when executed, cause the processor circuitry to select the upsampled input submatrix based on a position of a sliding window.

Example 13 includes the computer readable medium of any one of examples 8 to 10, wherein the selected four elements of the upsampled input submatrix correspond to four corners of the upsampled input submatrix.

Example 14 includes the computer readable medium of any one of examples 8 to 10, wherein the instructions, when executed, cause the processor circuitry to aggregate a plurality of convolved outputs, the convolved outputs generated by the convolving.

Example 15 includes an apparatus comprising means for detecting a pattern of an upsampled input submatrix, means for generating a transformed input submatrix by selecting four elements of the upsampled input submatrix, means for selecting a transformed weight submatrix based on the pattern, and means for convolving the transformed input submatrix and the transformed weight submatrix.

Example 16 includes the apparatus of example 15, wherein the upsampled input submatrix is based on an upsampled input matrix, the upsampled input matrix generated by nearest neighbor upsampling of an input matrix.

Example 17 includes the apparatus of example 15, wherein the upsampled input submatrix is a 3×3 matrix, the transformed input submatrix is a 2×2 matrix and the transformed weight submatrix is a 2×2 matrix.

Example 18 includes the apparatus of any one of examples 15 to 17, wherein the selected four elements of the upsampled input submatrix correspond to four corners of the upsampled input submatrix.

Example 19 includes the apparatus of any one of examples 15 to 17, further including means for selecting the upsampled input submatrix based on a position of a sliding window.

Example 20 includes the apparatus of any one of examples 15 to 17, further including means for aggregating a plurality of convolved outputs, the convolved outputs generated by the convolving.

Example 21 includes a method comprising detecting, by executing an instruction with processor circuitry, a pattern of an upsampled input submatrix, generating, by executing an instruction with the processor circuitry, a transformed input submatrix by selecting four elements of the upsampled input submatrix, selecting, by executing an instruction with the processor circuitry, a transformed weight submatrix based on the pattern, and convolving, by executing an instruction with the processor circuitry, the transformed input submatrix and the transformed weight submatrix.

Example 22 includes the method of example 21, wherein the upsampled input submatrix is based on an upsampled input matrix, the upsampled input matrix generated by nearest neighbor upsampling of an input matrix.

Example 23 includes the method of example 21, wherein the upsampled input submatrix is a 3×3 matrix, the transformed input submatrix is a 2×2 matrix, and the transformed weight submatrix is a 2×2 matrix.

Example 24 includes the method of any one of examples 21 to 23, further including selecting, by executing an instruction with the processor circuitry, the upsampled input submatrix based on a position of a sliding window.

Example 25 includes the method of any one of examples 21 to 23, further including aggregating, by executing an instruction with the processor circuitry, a plurality of convolved outputs, the convolved outputs generated by the convolving.

The following claims are hereby incorporated into this Detailed Description by this reference, with each claim standing on its own as a separate embodiment of the present disclosure.

1-25. (canceled)

26. An apparatus comprising:
memory;
machine-readable instructions; and
processor circuitry to execute the machine-readable instructions to:
detect a pattern of an upsampled input submatrix;
generate a transformed input submatrix by selecting four elements of the upsampled input submatrix;
select a transformed weight submatrix based on the pattern; and
convolve the transformed input submatrix and the transformed weight submatrix.

27. The apparatus of claim 26, wherein the upsampled input submatrix is based on an upsampled input matrix, the upsampled input matrix generated by nearest neighbor upsampling of an input matrix.

28. The apparatus of claim 26, wherein the upsampled input submatrix is a 3×3 matrix.

29. The apparatus of claim 26, wherein the transformed input submatrix is a 2×2 matrix and the transformed weight submatrix is a 2×2 matrix.

30. The apparatus of claim 26, wherein the processor circuitry is to execute the machine-readable instructions to select the upsampled input submatrix based on a position of a sliding window.

31. The apparatus of claim 26, wherein the selected four elements of the upsampled input submatrix correspond to four corners of the upsampled input submatrix.

32. The apparatus of claim 26, wherein the processor circuitry is to execute the machine-readable instructions to aggregate a plurality of convolved outputs, the convolved outputs generated by convolving the transformed input submatrix and the transformed weight submatrix.

33. A non-transitory computer readable medium comprising instructions, which, when executed, cause processor circuitry to at least:
detect a pattern of an upsampled input submatrix;
generate a transformed input submatrix by selecting four elements of the upsampled input submatrix;
select a transformed weight submatrix based on the pattern; and
convolve the transformed input submatrix and the transformed weight submatrix.

34. The non-transitory computer readable medium of claim 33, wherein the upsampled input submatrix is based on an upsampled input matrix, the upsampled input matrix generated by nearest neighbor upsampling of an input matrix.

35. The non-transitory computer readable medium of claim 33, wherein the upsampled input submatrix is a 3×3 matrix.

36. The non-transitory computer readable medium of claim 33, wherein the transformed input submatrix is a 2×2 matrix and the transformed weight submatrix is a 2×2 matrix.

37. The non-transitory computer readable medium of claim 33, wherein the instructions, when executed, cause the processor circuitry to select the upsampled input submatrix based on a position of a sliding window.

38. The non-transitory computer readable medium of claim 33, wherein the selected four elements of the upsampled input submatrix correspond to four corners of the upsampled input submatrix.

39. The non-transitory computer readable medium of claim 33, wherein the instructions, when executed, cause the processor circuitry to aggregate a plurality of convolved outputs, the convolved outputs generated by convolving the transformed input submatrix and the transformed weight submatrix.

40. An apparatus comprising:
means for detecting a pattern of an upsampled input submatrix;
means for generating a transformed input submatrix by selecting four elements of the upsampled input submatrix;
means for selecting a transformed weight submatrix based on the pattern; and
means for convolving the transformed input submatrix and the transformed weight submatrix.

41. The apparatus of claim 40, wherein the upsampled input submatrix is based on an upsampled input matrix, the upsampled input matrix generated by nearest neighbor upsampling of an input matrix.

42. The apparatus of claim 40, wherein the upsampled input submatrix is a 3×3 matrix, the transformed input submatrix is a 2×2 matrix and the transformed weight submatrix is a 2×2 matrix.

43. The apparatus of claim 40, wherein the selected four elements of the upsampled input submatrix correspond to four corners of the upsampled input submatrix.

44. The apparatus of claim 40, wherein the means for selecting is a first means for selecting, further including second means for selecting the upsampled input submatrix based on a position of a sliding window.

45. The apparatus of claim 40, further including means for aggregating a plurality of convolved outputs, the convolved outputs generated by the means for convolving.
